(19) United States
(12) Patent Application Publication
(10) Pub. No.: US 2026/0200365 A1
(43) Pub. Date: Jul. 16, 2026

(54) INFORMATION PROCESSING DEVICE

(71) Applicant: SANDEN CORPORATION, Isesaki-shi, Gunma (JP)

(72) Inventors: Kanta MORI, Isesaki-shi, Gunma (JP); Keiichi MORI, Isesaki-shi, Gunma (JP); Masashi WAKI, Isesaki-shi, Gunma (JP); Osamu TAKAZAWA, Isesaki-shi, Gunma (JP); Wataru IWAZAKI, Isesaki-shi, Gunma (JP)

(73) Assignee: SANDEN CORPORATION, Isesaki-shi, Gunma (JP)

(21) Appl. No.: 19/136,191

(22) PCT Filed: Dec. 25, 2023
(86) PCT No.: PCT/JP2023/046389

§ 371 Date: Jun. 5, 2025

(30) Foreign Application Priority Data
Jan. 23, 2023 (JP) 2023-008069

(51) Int. Cl. B60L 58/16; B60L 58/24

(52) U.S. Cl. CPC B60L 58/16; B60L 58/24; B60L 2250/18

(57) ABSTRACT

Provided is an information processing apparatus capable of proposing, to a user, battery degradation reduction control adapted to the orientation of the user toward use of a vehicle. An information processing apparatus 1 includes: an acquisition unit 12 configured to acquire driving information of a vehicle 3; a determination unit 14 configured to determine whether or not eco-driving is being performed on the vehicle 3 on the basis of the driving information acquired by the acquisition unit 12; and a proposal unit 15 configured to output information for proposing, to a user of the vehicle 3, battery degradation reduction control that reduces degradation of a battery 34 mounted on the vehicle 3 upon the determination unit 14 determining that eco-driving is being performed on the vehicle 3.

### TECHNICAL FIELD

The present invention relates to an information processing apparatus that proposes degradation reduction control over a battery mounted on a vehicle to a user.

### BACKGROUND ART

An information processing apparatus is conventionally known which provides a user of a vehicle such as an automobile with various kinds of information on the vehicle. For example, Patent Literature 1 discloses an information processing apparatus that analyzes value information of a battery on the basis of battery data transmitted from a vehicle equipped with the battery and request information from a user who secondarily uses the battery, and provides information on a sale thereof.

### CITATION LIST

### Patent Literature

Patent Literature 1: US 2021/0049480 A

### SUMMARY OF INVENTION

### Problems to Be Solved by Invention

Incidentally, for example, if secondary use of a battery mounted on a vehicle is assumed as in the above known technology, it is important to reduce deterioration of the battery. The state of the battery may change in various manners depending on how the user uses the vehicle. Battery degradation reduction control itself consumes electric power, which may influence, for example, the usability of the vehicle. In consideration of this respect, it is desirable to propose, to the user, battery degradation reduction control adapted to the orientation of the user toward the use of the vehicle. In the above known technology, information on the sale of the battery is provided, but it would not go as far as to propose battery degradation reduction control adapted to the orientation of the user.

The present invention has been made in view of the above respect, and an object thereof is to provide an information processing apparatus capable of proposing, to a user, battery degradation reduction control adapted to the orientation of the user toward use of a vehicle.

### Solution to Problems

In order to achieve the above object, an aspect of an information processing apparatus according to the present invention includes: an acquisition unit configured to acquire driving information of a vehicle; a determination unit configured to determine whether or not eco-driving is being performed on the vehicle on the basis of the driving information acquired by the acquisition unit; and a proposal unit configured to output information for proposing, to a user of the vehicle, battery degradation reduction control that reduces degradation of a battery mounted on the vehicle upon the determination unit determining that eco-driving is being performed on the vehicle.

### Effects of Invention

According to one aspect of an information processing apparatus of the present invention, it is possible to propose, to a user, battery degradation reduction control adapted to the orientation of the user toward use of a vehicle.

### BRIEF DESCRIPTION OF DRAWINGS

FIG. 1 is a diagram illustrating a configuration example of an information processing system including an information processing apparatus according to one embodiment of the present invention.

FIG. 2 is a block diagram illustrating a functional configuration example of a control device mounted on a vehicle in the above embodiment.

FIG. 3 is a flowchart illustrating the flow of a process that is executed by the information processing apparatus of the above embodiment.

FIG. 4 is a diagram illustrating an example of a screen on which a proposal for battery temperature adjustment control is displayed in the above embodiment.

FIG. 5 is a diagram illustrating an example of a screen on which a message to the effect of making settings for battery temperature adjustment control is displayed in the above embodiment.

### DESCRIPTION OF EMBODIMENTS

An embodiment of the present invention is described in detail hereinafter with reference to the accompanying drawings.

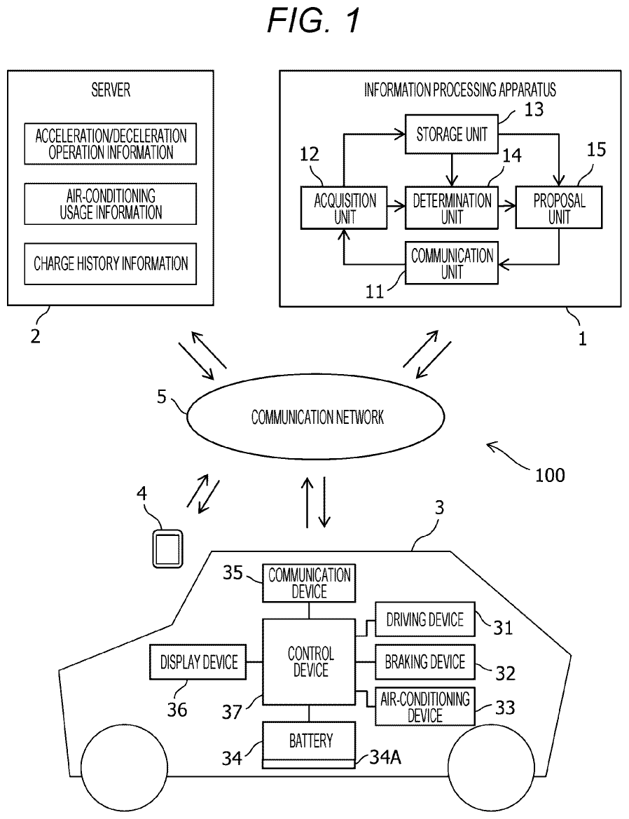

FIG. 1 is a diagram illustrating a configuration example of an information processing system 100 including an information processing apparatus 1 according to one embodiment of the present invention.

In FIG. 1, in the information processing system 100, the information processing apparatus 1 of the embodiment, a server 2, a vehicle 3, and a mobile device 4 possessed by a user of the vehicle 3 exchange information via a communication network 5; therefore, the information processing apparatus 1 outputs various kinds of proposal information to the user.

The information processing apparatus 1 includes, for example, a communication unit 11, an acquisition unit 12, a storage unit 13, a determination unit 14, and a proposal unit 15 as a functional configuration thereof. The hardware configuration of the information processing apparatus 1 includes, for example, a computer system including a processor, memory, a user input interface, and a communication interface although their illustrations are omitted here. In other words, in the information processing apparatus 1, the processor of the computer system reads and executes a program stored in the memory, thereby implementing the function of each block.

The acquisition unit 12 acquires driving information of the vehicle 3 stored in the server 2 via the communication unit 11 and the communication network 5. The driving information of the vehicle 3 includes acceleration/deceleration operation information, air-conditioning usage information, and charge history information.

The acceleration/deceleration operation information is information indicating the condition of operation for acceleration/deceleration by a user (driver) of the vehicle 3. The acceleration/deceleration operation information in the embodiment is information corresponding to the action of the driver operating the accelerator pedal (not illustrated) of the vehicle 3 to adjust the driving force of a driving device 31 (accelerator control), and the action of the driver operating the brake pedal (not illustrated) of the vehicle 3 to adjust the braking force of a braking device 32 (brake control).

The air-conditioning usage information is information indicating usage conditions such as switching-on/off, a temperature setting, and an air quantity setting of an air-conditioning device 33 mounted on the vehicle 3. The air-conditioning device 33 is, for example, an automotive air-conditioning system or a heater.

The charge history information is information indicating a charge history of a battery 34 mounted on the vehicle 3. The battery 34 is, for example, a lithium ion battery. The charge history information also includes information on charge modes such as a normal charge and a rapid charge.

The acceleration/deceleration operation information, the air-conditioning usage information, and the charge history information, which are stored in the server 2, are obtained by accumulating data (acceleration/deceleration data, air-conditioning use data, air-conditioning setting data, and charge data) that is transmitted from a communication device 35 of the vehicle 3 to the server 2 via the communication network 5 at required timings in association with identification information (a vehicle ID) of the vehicle 3 as described below. Note that the communication network 5 includes, for example, the Internet, a WAN (Wide Area Network), a LAN (Local Area Network), a provider apparatus, and a wireless base station.

In other words, the acquisition unit 12 of the information processing apparatus 1 transmits a signal that requests driving information of the vehicle 3 from the server 2 via the communication unit 11 and the communication network 5. In response to the request of the information processing apparatus 1, the server 2 transmits the acceleration/deceleration operation information, the air-conditioning usage information, and the charge history information, which are accumulated in association with the identification information of the vehicle 3, to the acquisition unit 12 via the communication network 5 and the communication unit 11. The acquisition unit 12 stores, in the storage unit 13, the driving information (the acceleration/deceleration operation information, the air-conditioning usage information, and the charge history information) of the vehicle 3 acquired from the server 2, and passes the driving information to the determination unit 14.

The determination unit 14 determines whether or not eco-driving is being performed on the vehicle 3 on the basis of the driving information of the vehicle 3 from the acquisition unit 12. Eco-driving is a method of using a vehicle in consideration of the reduction of environmental loads, and represents a driving method capable of reducing power (fuel) consumption and/or carbon dioxide emissions, and the user's efforts. The determination unit 14 in the embodiment estimates an orientation (eco-consciousness) of the user (driver) toward the driving method on the basis of the acceleration/deceleration operation information. Moreover, the determination unit 14 estimates an orientation (eco-consciousness) of the user toward an air-conditioning use method on the basis of the air-conditioning usage information. Furthermore, the determination unit 14 estimates an orientation (eco-consciousness) of the user toward a charging method on the basis of the charge history information. The determination unit 14 then comprehensively determines whether or not eco-driving is being performed on the vehicle 3 with reference to the estimated orientations of the user. Note that a specific determination method is described below. The determination result of the determination unit 14 is passed to the proposal unit 15.

If the determination unit 14 determines that eco-driving is being performed on the vehicle 3, the proposal unit 15 generates and outputs information for proposing, to the user, battery degradation reduction control for reducing the degradation of the battery 34 of the vehicle 3. Battery degradation reduction control is, for example, battery temperature adjustment control that adjusts the temperature of the battery 34. A case where the proposal unit 15 outputs information for proposing battery temperature adjustment control is described below. However, battery degradation reduction control in the present invention is not limited to battery temperature adjustment control.

Specifically, the proposal unit 15 in the embodiment generates proposal information including characters and images for proposing battery temperature adjustment control to the user in association with the identification information of the vehicle 3 that has been determined by the determination unit 14 as eco-driving. The proposal information generated by the proposal unit 15 is outputted to the communication unit 11. The communication unit 11 transmits the proposal information from the proposal unit 15 to the vehicle 3 or the mobile device 4 via the communication network 5.

The vehicle 3 that receives the proposal information from the information processing apparatus 1 via the communication network 5 includes a display device 36 and a control device 37 in addition to the above-mentioned driving device 31, braking device 32, air-conditioning device 33, battery 34, and communication device 35. The vehicle 3 in the embodiment is assumed to be, for example, an electric vehicle, but may be a hybrid vehicle.

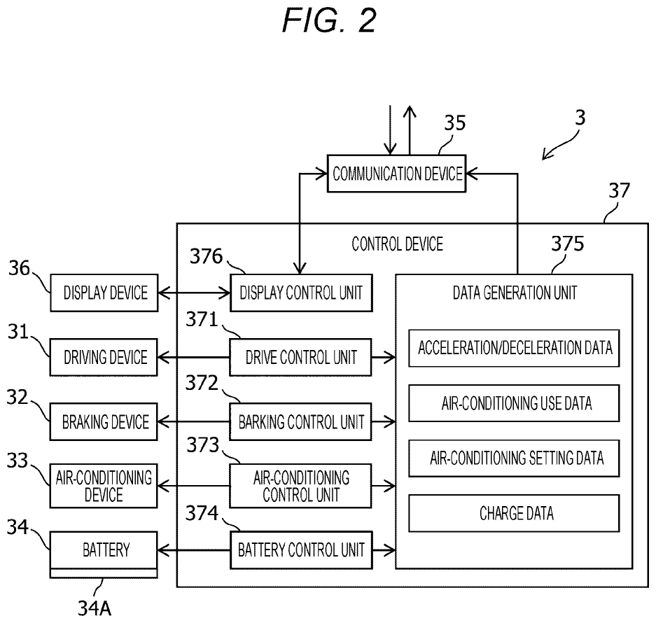

FIG. 2 is a block diagram illustrating a functional configuration example of the control device 37 mounted on the vehicle 3 in the embodiment.

In FIG. 2, the control device 37 is configured, including a drive control unit 371, a braking control unit 372, an air-conditioning control unit 373, a battery control unit 374, a data generation unit 375, and a display control unit 376.

The drive control unit 371 controls the driving force of the driving device 31 mounted on the vehicle 3 according to the amount of operation of the accelerator pedal by the user (driver) of the vehicle 3. The driving device 31 is, for example, an electric motor or an engine. The electric motor is driven by receiving the supply of power from the battery 34. The drive control unit 371 is configured in such a manner as to be capable of outputting signals indicating the state of operation of the accelerator pedal by the user to the data generation unit 375.

The braking control unit 372 controls the braking force of the braking device 32 mounted on the vehicle 3 according to the amount of operation of the brake pedal by the user (driver) of the vehicle 3. The braking device 32 is, for example, the foot brake, the regenerative brake, the engine brake, or the parking brake. The braking control unit 372 is configured in such a manner as to be capable of outputting signals indicating the state of operation of the brake pedal by the user to the data generation unit 375.

The air-conditioning control unit 373 controls the operation of the air-conditioning device 33 such as an automotive air-conditioning system or heater mounted on the vehicle 3 with reference to the condition of operation of an air-conditioning operation panel (not illustrated) provided to the vehicle 3. On the air-conditioning operation panel, the user of the vehicle 3 performs operations such as switching-on/off of the air conditioning device 33, setting of the temperature and the air quantity, and switching between automatic mode and manual mode. The air-conditioning control unit 373 is configured in such a manner as to be capable of outputting signals indicating the state of control (such as switching on/off and setting of the temperature and the air quantity) of the air-conditioning device 33 to the data generation unit 375.

The battery control unit 374 controls charging and discharging of the battery 34 mounted on the vehicle 3. When an external charger (not illustrated) is connected to a charging port of the battery 34, the battery control unit 374 communicates with the external charger to control the state of charge of the battery 34. The battery 34 in the embodiment is provided with a temperature adjustment unit 34A that can adjust the temperature of the battery 34. The temperature adjustment unit 34A includes, for example, an air-cooling device having a fan that cools the battery 34 by blowing air to the battery 34, and a liquid-cooling device having a heating medium circuit that adjusts the temperature of the battery 34 by circulating a heating medium in the battery 34. The battery control unit 374 in the embodiment can also control the operation of the temperature adjustment unit 34A in accordance with the settings of battery temperature adjustment control. The battery control unit 374 is configured in such a manner as to be capable of outputting signals indicating the state of charge/discharge of the battery 34 to the data generation unit 375.

The data generation unit 375 generates acceleration/deceleration operation data with reference to the states of operation of the accelerator pedal and the brake pedal by the user (driver) by use of the output signals from the drive control unit 371 and the braking control unit 372. The change of the acceleration/deceleration operation data over time indicates how the user operates the accelerator pedal and the brake pedal, that is, how the user drives the vehicle 3 (driving habits).

Moreover, the data generation unit 375 uses the output signals from the air-conditioning control unit 373 to generate air-conditioning use data indicating the operating state (on/off) of the air-conditioning device 33 and air-conditioning setting data indicating settings of the temperature and the air quantity of the air-conditioning device 33. The changes of the air-conditioning use data and the air-conditioning setting data over time indicate how the user of the vehicle 3 uses the air-conditioning device 33.

Furthermore, the data generation unit 375 generates charge data indicating the state of charge of the battery 34 by use of the output signals from the battery control unit 374. The charge data includes not only information on whether or not the battery 34 is charged but also information on the remaining capacity and charge mode (such as a normal charge or a rapid charge) of the battery 34 at the start of charging. The change of the charge data over time (the charge history) indicates at what timing and in what mode the user of the vehicle 3 charges the battery 34.

The acceleration/deceleration operation data, the air-conditioning use data, the air-conditioning setting data, and the charge data, which are generated by the data generation unit 375 as described above, are outputted to the communication device 35 of the vehicle 3. The communication device 35 transmits the output data of the data generation unit 375 to the server 2 via the communication network 5 (FIG. 1). The server 2, which has received the transmission data from the vehicle 3, generates the acceleration/deceleration operation information by accumulating the acceleration/deceleration operation data, generates the air-conditioning usage information by accumulating the air-conditioning use data and the air-conditioning setting data, and generates the charge history information by accumulating the charge data, in association with the identification information of the vehicle 3.

Moreover, the communication device 35 of the vehicle 3 receives the proposal information on battery temperature adjustment control transmitted from the information processing device 1 to the communication network 5, and passes, to the display control unit 376 of the control device 37, proposal information corresponding to its own identification information among the proposal information (FIG. 2).

The display control unit 376 controls the display state of the display device 36 mounted on the vehicle 3. The display device 36 is, for example, a display of an automotive navigation system. The display control unit 376 causes the display device 36 to display, for example, characters and images for proposing battery temperature adjustment control in accordance with the proposal information passed from the communication device 35. Note that in the embodiment, a description is given of an example in which the proposal for battery temperature adjustment control is displayed on the display device 36 of the vehicle 3. However, for example, if the vehicle 3 is not provided with, for example, a display of an automotive navigation system, the proposal for battery temperature adjustment control may be displayed on the mobile device 4 (FIG. 1) possessed by the user of the vehicle 3.

The mobile device 4 is, for example, a smartphone or tablet terminal including a communication function that can be connected to the communication network 5. An application program provided for the information processing apparatus 1 is installed in the mobile device 4, and the identification information of the vehicle 3 owned by the user of the mobile device 4 is registered in advance in the application program.

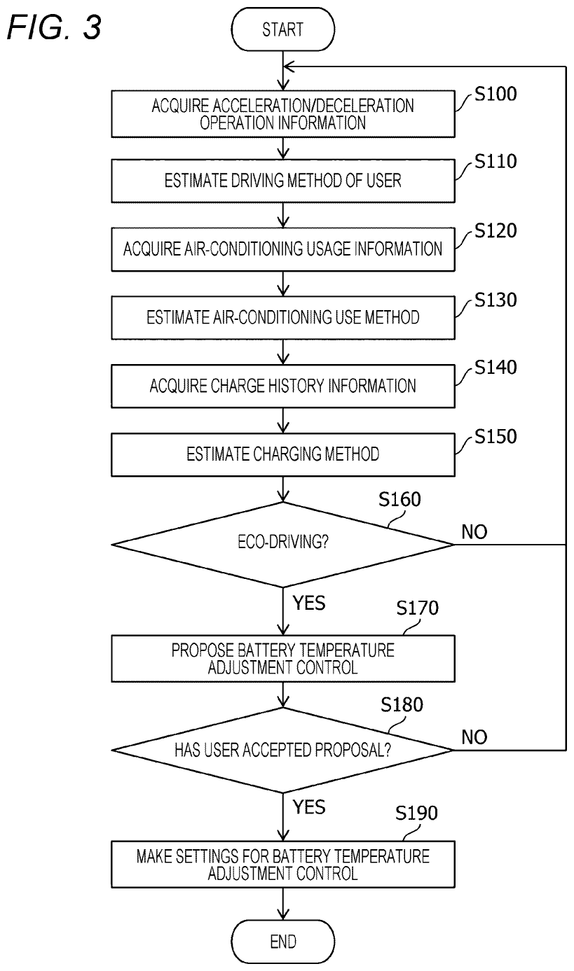

Next, the operation of the information processing apparatus 1 according to the embodiment is described in detail with reference to the flowchart of FIG. 3.

In the information processing apparatus 1 according to the embodiment, first, in step S100 of FIG. 3, the acquisition unit 12 accesses the server 2 via the communication unit 11 and the communication network 5, and acquires the acceleration/deceleration operation information of the vehicle 3 stored in the server 2.

In step S110, the determination unit 14 then estimates the orientation (eco-consciousness) of the user (driver) of the vehicle 3 toward the driving method on the basis of the acceleration/deceleration operation information acquired in step S100. Specifically, for example, if the acceleration/deceleration operation information indicates that the number of times of occurrence of hard acceleration and hard braking in a predetermined period (for example, one month) is equal to or less than a predetermined value (for example, three times or less), the driving method of the user can be estimated as eco-oriented. Such an estimation of the orientation of the user toward the driving method is preferably provided after a point in time when the travel distance reaches 3000 km since the user starts using the vehicle 3. Consequently, it is possible to improve the accuracy of the estimation of the orientation of the user toward the driving method.

In the next step S120, the acquisition unit 12 acquires the air-conditioning usage information of the vehicle 3 stored in the server 2. In step S130, the determination unit 14 then estimates the orientation (eco-consciousness) of the user of the vehicle 3 toward the air-conditioning use method on the basis of the air-conditioning usage information acquired in step S120. Specifically, for example, if the air-conditioning usage information indicates that the temperature setting in the summer months is 28° C. or higher, the air-conditioning use method of the user can be estimated as eco-oriented. Such an estimation of the orientation of the user toward the air-conditioning use method is preferably provided after a point in time when one year passes since the user starts using the vehicle 3. Consequently, it is possible to improve the accuracy of the estimation of the orientation of the user toward the air-conditioning use method.

In the next step S140, the acquisition unit 12 acquires the charge history information of the vehicle 3 stored in the server 2. In step S150, the determination unit 14 then estimates the orientation (eco-consciousness) of the user of the vehicle 3 toward the charging method on the basis of the charge history information acquired in step S140. Specifically, for example, if the charge history information indicates that the number of times of start of charging within a range where the remaining capacity of the battery 34 is 20% to 80% in a predetermined period (for example, one month) is equal to or more than a predetermined value (for example, three times or more), the charging method of the user can be estimated as eco-oriented. Such an estimation of the orientation of the user toward the charging method is preferably provided after a point in time when the travel distance reaches 3000 km since the user starts using the vehicle 3. Consequently, it is possible to improve the accuracy of the estimation of the orientation of the user toward the charging method.

In the following step S160, the determination unit 14 comprehensively determines whether or not eco-driving is being performed on the vehicle 3 in accordance with the estimation results of the above steps S110, S130, and S150. In the embodiment, it is determined that eco-driving is being performed on the vehicle 3 if it is estimated that at least one of the user's orientation toward the driving method, orientation toward the air-conditioning use method, or orientation toward the charging method is eco-oriented, otherwise it is determined that eco-driving is not being performed on the vehicle 3. If it is determined that eco-driving is being performed on the vehicle 3 (YES), the procedure moves on to the next step S170. On the other hand, if it is determined that eco-driving is not being performed on the vehicle 3 (NO), the procedure returns to step S100 and repeats the above-mentioned series of processes.

In step S170, the proposal unit 15 generates the proposal information including characters and images for proposing battery temperature adjustment control to the user in association with the identification information of the vehicle 3 that has been determined as eco-driving in step S160. This proposal information includes, for example, character information “Eco-driving extends battery life. Do you want to perform better battery temperature control than now to extend battery life?” and image information of a button on which characters “Yes” are drawn and of a button on which characters “No” are drawn.

The proposal information generated by the proposal unit 15 is outputted to the communication unit 11 and transmitted from the communication unit 11 to the vehicle 3 (or the mobile device 4) via the communication network 5. In the vehicle 3, the proposal information from the information processing apparatus 1 is received by the communication device 35 and passed to the display control unit 376. Consequently, the characters and images (buttons) included in the proposal information are displayed on the display device 36.

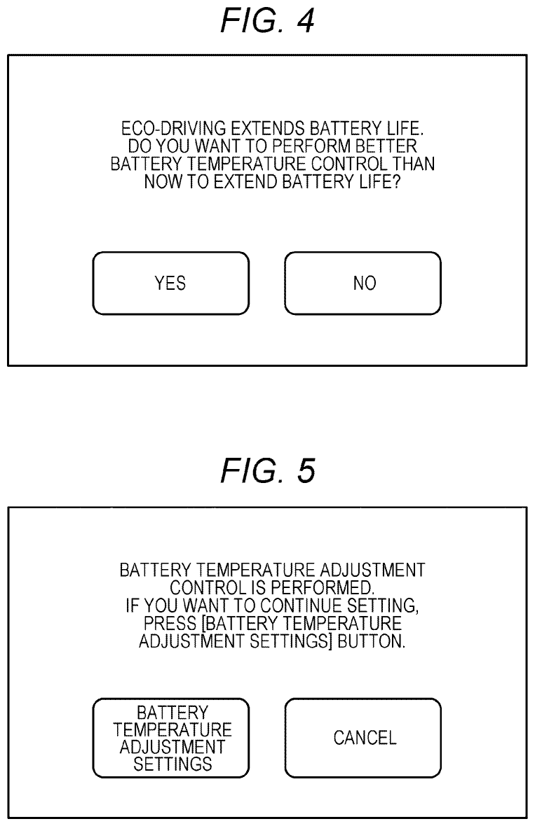

FIG. 4 illustrates an example of a screen of the display device 36 on which the proposal for battery temperature adjustment control is displayed by the process of step S170. The user of the vehicle 3 checks the contents of the proposal displayed on the display device 36, and touches the button “Yes” if accepting the proposal or touches the button “No” if not accepting the proposal. If the button “Yes” or “No” is touched, a signal indicating the touch is outputted from the display control unit 376 to the communication device 35 and transmitted to the information processing apparatus 1 via the communication network 5.

In the following step S180 (FIG. 3), the proposal unit 15 determines whether or not the user of the vehicle 3 has accepted the proposal. If the user has accepted the proposal, in other words, if a signal indicating that the button “Yes” has been touched is sent from the vehicle 3 to the information processing apparatus 1 via the communication network 5 (YES), the procedure moves on to the next step S190. On the other hand, if the user has not accepted the proposal, in other words, if a signal indicating that the button “No” has been touched is sent from the vehicle 3 to the information processing apparatus 1 via the communication network 5 (NO), the procedure returns to step S100 and repeats the above-mentioned series of processes.

In step S190, the proposal unit 15 generates check information to the effect of making settings for battery temperature adjustment control. This check information includes, for example, character information “Battery temperature adjustment control is performed. If you want to continue the setting, press the [battery temperature adjustment settings] button.” and image information of a button on which characters “battery temperature adjustment settings” are drawn and of a button on which characters “cancel” are drawn.

The check information generated by the proposal unit 15 is outputted to the communication unit 11 and transmitted from the communication unit 11 to the vehicle 3 (or the mobile device 4) via the communication network 5. In the vehicle 3, the check information from the information processing apparatus 1 is received by the communication device 35 and passed to the display control unit 376. Consequently, the characters and images (buttons) included in the check information are displayed on the display device 36.

FIG. 5 illustrates an example of a screen that displays a message to the effect of making settings for battery temperature adjustment control is displayed by the process of step S190. The user of the vehicle 3 checks the message displayed on the display device 36 and, if continuing making settings for battery temperature adjustment control, touches the “battery temperature adjustment settings” button. If the user touches the “battery temperature adjustment settings” button, a setting screen of battery temperature adjustment control is displayed by the display control unit 376 on the display device 36 although its illustration is omitted here. On the other hand, if settings are not made for battery temperature adjustment control, the user touches the “cancel” button to stop the process.

Next, effects of the information processing apparatus 1 according to the embodiment are described.

In such an information processing apparatus 1 according to the embodiment as described above, if the determination unit 14 determines that eco-driving is being performed on the vehicle 3 on the basis of the driving information of the vehicle 3 acquired by the acquisition unit 12, the proposal unit 15 outputs the information for proposing battery degradation reduction control to the user. According to such an information processing apparatus 1, it is possible to effectively propose battery degradation reduction control to a user who is highly likely to always keep eco-driving in mind. Since the proposal for battery degradation reduction control is not made to a user who is less likely to always keep eco-driving in mind, it is possible to avoid a situation in which the user feels annoyed.

Moreover, in the information processing apparatus 1 of the embodiment, the determination unit 14 estimates the orientation of the user toward the driving method on the basis of the acceleration/deceleration operation information, and determines whether or not eco-driving is being performed on the vehicle 3 in accordance with the estimation result. Consequently, it is possible to more effectively propose battery degradation reduction control to a user who is highly likely to be eco-oriented in terms of the driving method of the vehicle 3.

Moreover, in the information processing apparatus 1 of the embodiment, the determination unit 14 estimates the orientation of the user toward the air-conditioning use method on the basis of the air-conditioning usage information, and determines whether or not eco-driving is being performed on the vehicle 3 in accordance with the estimation result. Consequently, it is possible to more effectively propose battery degradation reduction control to a user who is highly eco-oriented in terms of the use method of the air-conditioning device 33 of the vehicle 3.

Moreover, in the information processing apparatus 1 of the embodiment, the determination unit 14 estimates the orientation of the user toward the charging method on the basis of the charge history information of the battery 34, and determines whether or not eco-driving is being performed on the vehicle 3 in accordance with the estimation result. Consequently, it is possible to more effectively propose battery degradation reduction control to a user who is highly eco-oriented in terms of the battery charging method.

Moreover, in the information processing apparatus 1 of the embodiment, battery temperature adjustment control that adjusts the temperature of the battery is proposed as the proposal for battery degradation reduction control. Consequently, it is possible to propose control that can reliably reduce the degradation of the battery 34 caused at high temperatures or low temperatures.

Up to this point the embodiment of the present invention has been described. However, the present invention is not limited to the above-mentioned embodiment, and can be modified or altered in various manners on the basis of the technical idea of the present invention.

For example, in the above-mentioned embodiment, an example has been described in which the information processing apparatus 1 communicates with the communication device 35 of the vehicle 3 via the communication network 5. However, the information processing apparatus 1 may be mounted on the vehicle 3 to directly convey information to and from the control device 37.

Moreover, in the above-mentioned embodiment, an example has been described in which the determination unit 14 of the information processing apparatus 1 determines that eco-driving is being performed on the vehicle 3 if estimating that at least one of the orientations of the user toward the driving method, the air-conditioning use method, and the battery charging method is eco-oriented. However, it may be determined that eco-driving is being performed on the vehicle 3 on condition that the user is estimated as eco-oriented in terms of all these methods. Alternatively, priority may be given between the driving method, the air-conditioning use method, and the battery charging method to estimate whether the user is eco-oriented and make a determination about eco-driving on the vehicle 3.

### LIST OF REFERENCE SIGNS

1 Information processing apparatus
2 Server
3 Vehicle
4 Mobile device
5 Communication network
11 Communication unit
12 Acquisition unit
13 Storage unit
14 Determination unit
15 Proposal unit
31 Driving device
32 Braking device
33 Air-conditioning device
34 Battery
34A Temperature adjustment unit
35 Communication device
36 Display device
37 Control device
100 Information processing system
371 Drive control unit
372 Braking control unit
373 Air-conditioning control unit
374 Battery control unit
375 Data generation unit
376 Display control unit

1. An information processing apparatus comprising:
an acquisition unit configured to acquire driving information of a vehicle;
a determination unit configured to determine whether or not eco-driving is being performed on the vehicle on the basis of the driving information acquired by the acquisition unit; and
a proposal unit configured to output information for proposing, to a user of the vehicle, battery degradation reduction control that reduces degradation of a battery mounted on the vehicle upon the determination unit determining that eco-driving is being performed on the vehicle.

2. The information processing apparatus according to claim 1, wherein
the driving information includes acceleration/deceleration operation information indicating a condition of operation of acceleration/deceleration by the user of the vehicle, and
the determination unit estimates an orientation of the user toward a driving method on the basis of the acceleration/deceleration operation information included in the driving information acquired by the acquisition unit, and determines whether or not eco-driving is being performed on the vehicle in accordance with a result of the estimation.

3. The information processing apparatus according to claim 1, wherein
the driving information includes air-conditioning usage information indicating usage conditions of an air-conditioning device mounted on the vehicle, and
the determination unit estimates an orientation of the user toward an air-conditioning use method on the basis of the air-conditioning usage information included in the driving information acquired by the acquisition unit, and determines whether or not eco-driving is being performed on the vehicle in accordance with a result of the estimation.

4. The information processing apparatus according to claim 1, wherein
the driving information includes charge history information indicating a charge history of the battery, and
the determination unit estimates an orientation of the user toward a charging method on the basis of the charge history information included in the driving information acquired by the acquisition unit, and determines whether or not eco-driving is being performed on the vehicle in accordance with a result of the estimation.

5. The information processing apparatus according to claim 1, wherein the battery degradation reduction control is battery temperature adjustment control that adjusts a temperature of the battery.
